(19) United States
(12) Patent Application Publication
(10) Pub. No.: US 2016/0109653 A1
(43) Pub. Date: Apr. 21, 2016

(54) OPTICAL INTERCONNECTS AND METHODS OF FABRICATING SAME

(71) Applicant: GEORGIA TECH RESEARCH CORPORATION, Atlanta, GA (US)

(72) Inventors: William A. Vis, Atlanta, GA (US); Bruce Chia-Te Chou, Atlanta, GA (US); Venkatesh Sundaram, John's Creek, GA (US); Rao R. Tummala, Greenboro, GA (US); Terry P. Bowen, Atlanta, GA (US); Jibin Sun, Atlanta, GA (US)

(21) Appl. No.: 14/884,242

(22) Filed: Oct. 15, 2015

Related U.S. Application Data
(60) Provisional application No. 62/064,225, filed on Oct. 15, 2014.
(60) Provisional application No. 62/087,020, filed on Dec. 3, 2014.

(51) Int. Cl. G02B 6/12; G02B 6/26; G02B 6/122; G02B 6/136; G02B 6/132

(52) U.S. Cl. CPC G02B 6/12002; G02B 6/136; G02B 6/132; G02B 6/122; G02B 6/268; G02B 2006/12069; G02B 2006/12147

(57) ABSTRACT

An embodiment provides an optical interconnect comprising first and second planar metallization layers, a glass substrate disposed between at least portions of the first and second metallization layers, an aperture in the second metallization layer having a first and second ends, and a polymer waveguide having a first end adjacent the first end of the aperture. The first end of the waveguide can have a first edge defining a first acute angle with respect to a top surface of the waveguide. The first end of the optical waveguide can be configured to receive an optical signal traversing through the glass substrate from a source proximate a first position on a top surface of the glass substrate and direct the optical signal with the first edge in a direction parallel to the glass substrate towards a second end of the waveguide.

### CROSS-REFERENCE TO RELATED APPLICATIONS

This application claims the benefit of U.S. Provisional Application Ser. Nos. 62/064,225, filed on Oct. 15, 2015, and 62/087,020, filed on Dec. 3, 2014, which are incorporated herein by reference in their entireties as if fully set forth below.

### TECHNICAL FIELD OF THE INVENTION

The various embodiments of the present disclosure relate generally to interconnects for electronic devices. More particularly, the various embodiments of the present invention are directed to interconnects with optical waveguides and methods of fabricating the same.

### BACKGROUND OF THE INVENTION

Since the advent of the optical fiber, optical interconnections have been a viable alternative to their electronic counterparts due their high bandwidth potential. The extremely low loss of optical interconnections in glass compared to their electrical counterpart makes them the de facto candidate for long distance transmissions. Ever increasing bandwidth demands have pushed the need for optical interconnection at shorter and shorter transmission distances. As optical interconnects transition from board-to-board to chip-to-chip applications, out-of-plane turning continues to be an important issue. Out-of-plane turning is most commonly achieved with diffraction gratings or micro mirrors. The typical operating wavelength of light for photonic applications (λ=850, 1350, 1550 nm) requires submicron resolution for diffraction gratings, which make them impractical at package level. On the other hand, turning micro mirrors operate at all length scales, making them the preferred choice at package level. To date, micro mirrors are fabricated serially using laser ablation or simultaneously using lithographic techniques.

Many intensive research efforts have been done to develop a process for the simultaneous manufacturing of multiple out-of-plane turning surfaces. Several photolithographic techniques have been reported, including the ‘gradient mask method’, the ‘moving mask method’, and inclined lithography. The gradient mask method generates gradient exposure intensity by a grayscale mask, while moving mask method generates the same gradient by a translation of the substrate or mask during exposure. However, commonly-available photosensitive polymers have a single optimal exposure intensity that defines a well-developed polymer structure. As a result, these methods may not be well-suited for development of high quality turning surfaces. Moreover, most of these polymers are in available published work as only positive-toned photosensitive polymers, defined by gradient or moving mask. As such, these two methods demand a positive-tone photosensitive material with consistent high resolution at a range of exposure dosages. Inclined lithography, however, does not require precise exposure gradient because a constant exposure is used to define the polymer microstructure. Further, inclined lithography has also been reported for both positive and negative photosensitive polymers. Inclined lithography is not without its own limitations. First, a 45 degree turning angle is not achievable using inclined lithography in air. The high index of refraction contrast between air (n₁=1) and photosensitive polymers (typically 1.5<n₂<1.6) does not allow a turning angle greater than the critical angle established by Snell's Law.

n₁ sin θ₁=n₂ sin θ₂ Equation 1

Arranging for the critical angle gives for light going from n₁ to n₂,

$${θ}_{cr} = {sin}^{- 1} ( \frac{{n}_{1}}{{n}_{2}} sin {θ}_{i} ) , \qquad Equation 2$$

where θᵢ is the incident angle which has a maximum of θᵢ=90 degrees giving,

$${θ}_{cr} = {sin}^{- 1} ( \frac{{n}_{1}}{{n}_{2}} ) . \qquad Equation 3$$

When fabricating a polymer waveguide with n₁=1 and n₂=1.5, the critical angle, or the maximum turning angle, calculated using Equation 3 is 41.8 degrees. FIG. 2a illustrates the critical angle at maximum incident.

Second, the shape of the geometry cannot be achieved by inclined lithography unless there is a zero gap mask contact to the polymer. One solution to ensure good contact is by using a direct-coated mask. In fact, a high-quality polymer microstructure with 45 degree turning has been fabricated on a glass mask, without a substrate. However, this process requires an additional transfer step to a substrate, typically by molding. Consequently, the alignment of the three-dimensional waveguide (“3D WG”) to a light source assembled on the substrate is entirely dictated by the alignment precision in the transfer step. Lastly, it is difficult to achieve a symmetrical geometry for the waveguide with a single exposure. Conventional methods achieve the microstructure being achieved by a double exposure method. An alternative method to double exposure involves using a reflective substrate. Again, this requires a secondary transfer step.

Therefore, there is a desire for improved optical interconnects that overcome the problems with the prior art identified above. Various embodiments of the present invention address these desires.

### BRIEF SUMMARY OF THE INVENTION

The present invention relates to interconnects with optical waveguides and methods of fabricating the same. An exemplary embodiment of the present invention provides method of fabricating an optical interconnect. The method comprises providing an interconnect structure comprising a planar glass substrate, a planar first metallization layer adjacent to a top side of the glass substrate, a planar second metallization layer adjacent to a bottom side of the glass substrate, a planar first photoresist layer adjacent to a top side of the first metallization layer opposite the glass substrate, and a planar second photoresist layer adjacent to a bottom side of the second metallization layer opposite the glass substrate. The method further comprises using the first photoresist layer to etch a portion of the first metallization layer to form a first aperture in the first metallization layer, using the second photoresist layer to etch a portion of the second metallization layer offset from the portion of the first metallization layer to form a second aperture in the second metallization layer, removing the first and second photoresist layers, depositing a planar photo-definable material layer adjacent to a bottom side of the second metallization layer opposite the glass substrate, immersing at least a bottom portion of the photo-definable material layer in a fluid having a refractive index different from a refractive index of the glass substrate, and applying light at a non-normal angle to the top side of the first metallization layer. Application of the light can cause at least a portion of the light to traverse through the first aperture, the glass substrate, and the second aperture to be incident upon the photo-definable material layer and so that at least a second portion of the light is reflected by the fluid, forming a waveguide in the photo-definable material. The formed waveguide can comprise a first end adjacent a first end of the etched portion of the second metallization layer and a second end adjacent a second end of the etched portion of second metallization layer.

In some embodiments of the present invention at least one of the first and second ends of the formed waveguide can define an acute angle with respect to a top surface of the formed waveguide proximate the glass substrate. In some embodiments of the present invention, the acute angle is between 40 and 50 degrees. In some embodiments of the present invention, the acute angle is 45 degrees.

In some embodiments of the present invention, an angle defined by the first end of the formed waveguide with respect to a top surface of the formed waveguide proximate the glass substrate can be different than an angle defined by the second end of the formed waveguide with respect to the top surface of the formed waveguide proximate the glass substrate.

In some embodiments of the present invention, the method further comprises determining the non-normal angle at which the light is applied based at least in part on a desired angle to be defined by at least one of the first and second ends of the formed waveguide with respect to a top surface of the formed waveguide proximate the glass substrate.

In some embodiments of the present invention, the method further comprises determining an offset between a first end of the etched portion of the first metallization layer and a first end of the etched portion of the second metallization layer based at least in part on a desired length of the formed waveguide.

In some embodiments of the present invention, the photo-definable material layer comprises a negative tone material. In some embodiments of the present invention, the photo-definable material layer comprises a low-loss polymer.

In some embodiments of the present invention, the method further comprises etching an elliptically-shaped ring into the top side of the glass substrate opposite the first end of the formed waveguide.

In some embodiments of the present invention, the method further comprises at least partially filling the elliptically-shaped ring with a cladding material.

In some embodiments of the present invention, the fluid is water.

In some embodiments of the present invention, at least one of the first and second metallization layers comprises copper.

In some embodiments of the present invention, the glass substrate comprises at least one through via.

Another embodiment of the present invention provides a method of fabricating an optical interconnect comprising providing an interconnect structure comprising a planar glass substrate, a planar first metallization layer adjacent to a top surface of the glass substrate, and a planar second metallization layer adjacent to a bottom surface of the glass substrate, forming a first aperture through the first metallization layer, forming a second aperture through the second metallization layer, wherein the first aperture is offset from the second aperture, depositing a photo-definable material layer adjacent to a bottom surface of the second metallization layer opposite the glass substrate, immersing at least a portion of the photo-definable material layer in a fluid having a refractive index that is different from a refractive index of the glass substrate, and applying light at a non-normal angle to a top surface of the first metallization layer opposite the glass substrate so that at least a first portion of the light traverses through the first aperture, the glass substrate, and the second aperture to be incident upon the photo-definable material layer and so that at least a second portion of the light is reflected by the fluid, forming a waveguide in the photo-definable material.

In some embodiments of the present invention, the formed waveguide comprises a first end adjacent a first end of the second aperture and a second end adjacent a second end of the second aperture.

In some embodiments of the present invention, the method further comprises determining the non-normal angle at which the light is applied based at least in part on a desired acute angle to be defined by at least one of the first and second ends of the formed waveguide with respect to a top surface of the formed waveguide proximate the glass substrate.

In some embodiments of the present invention, the method further comprises etching an elliptically-shaped ring into the top surface of the glass substrate opposite the first end of the formed waveguide.

In some embodiments of the present invention, the method further comprises at least partially filling the elliptically-shaped ring with a cladding material.

In some embodiments of the present invention, the method further comprises determining the offset between a first end of the first aperture and a first end of the second aperture based at least in part on a desired length of the formed waveguide.

Another embodiment of the present invention provides optical interconnect. The optical interconnect can comprise a planar first metallization layer, a planar second metallization layer, a glass substrate disposed between the at least portions of the first and second metallization layers, a first aperture in the second metallization layer having a first end and a second end, and a polymer waveguide having a first end adjacent the first end of the first aperture. The first end of the waveguide can have a first edge defining a first acute angle with respect to a top surface of the waveguide proximate a bottom surface of the glass substrate. The first end of the optical waveguide can be configured to receive an optical signal traversing through the glass substrate from a source proximate a first position on a top surface of the glass substrate and direct the optical signal with the first edge in a direction parallel to the glass substrate towards a second end of the waveguide.

In some embodiments of the present invention, the first acute angle can be between 40 degrees and 50 degrees. In some embodiments of the present invention, the first acute angle can be 45 degrees.

In some embodiments of the present invention, the glass substrate can further comprise a elliptically-shaped ring etched into the glass substrate and surrounding the first position on the top surface of the glass substrate. The ring can be configured to limit the dispersion of the optical source in the glass substrate.

In some embodiments of the present invention, the elliptically-shaped ring can be at least partially filled with a cladding material.

In some embodiments of the present invention, the second end of the waveguide can have a second edge defining a second acute angle with respect to the top surface of the waveguide proximate the bottom surface of the glass substrate.

In some embodiments of the present invention, the second acute angle is between 40 degrees and 50 degrees. In some embodiments of the present invention, the second acute angle is 45 degrees.

In some embodiments of the present invention, the first acute angle is different than the second acute angle.

In some embodiments of the present invention, the second end of the optical waveguide can be configured to direct the optical signal with the second edge through the glass substrate in a direction perpendicular to the glass substrate to a destination proximate a second position on a top surface of the glass substrate.

In some embodiments of the present invention, the glass substrate can further comprise an elliptically-shaped ring etched into the glass substrate and surrounding the second position on the top surface of the glass substrate. The ring configured to limit the dispersion of the optical source in the glass substrate.

In some embodiments of the present invention, the elliptically-shaped ring can be at least partially filled with a cladding material.

These and other aspects of the present invention are described in the Detailed Description of the Invention below and the accompanying figures. Other aspects and features of embodiments of the present invention will become apparent to those of ordinary skill in the art upon reviewing the following description of specific, exemplary embodiments of the present invention in concert with the figures. While features of the present invention may be discussed relative to certain embodiments and figures, all embodiments of the present invention can include one or more of the features discussed herein. Further, while one or more embodiments may be discussed as having certain advantageous features, one or more of such features may also be used with the various embodiments of the invention discussed herein. In similar fashion, while exemplary embodiments may be discussed below as device, system, or method embodiments, it is to be understood that such exemplary embodiments can be implemented in various devices, systems, and methods of the present invention.

### BRIEF DESCRIPTION OF THE DRAWINGS

The following Detailed Description of the Invention is better understood when read in conjunction with the appended drawings. For the purposes of illustration, there is shown in the drawings exemplary embodiments, but the subject matter is not limited to the specific elements and instrumentalities disclosed.

FIG. 1a provides a step in a process of fabricating optical interconnects, in accordance with an exemplary embodiment of the present invention.

FIG. 1b provides a step in a process of fabricating optical interconnects, in accordance with an exemplary embodiment of the present invention.

FIG. 1c provides a step in a process of fabricating optical interconnects, in accordance with an exemplary embodiment of the present invention.

FIG. 1d provides a step in a process of fabricating optical interconnects, in accordance with an exemplary embodiment of the present invention.

FIG. 1e provides a step in a process of fabricating optical interconnects, in accordance with an exemplary embodiment of the present invention.

FIG. 1f provides a step in a process of fabricating optical interconnects, in accordance with an exemplary embodiment of the present invention.

FIG. 2 provides ray behavior for a critical angle from air to polymer wherein the index of refractions (n) are given for λ=365 nm, in accordance with an exemplary embodiment of the present invention.

FIG. 3a provides a step in a process of fabricating optical interconnects, in accordance with an exemplary embodiment of the present invention.

FIG. 3b provides a step in a process of fabricating optical interconnects, in accordance with an exemplary embodiment of the present invention.

FIG. 3c provides a step in a process of fabricating optical interconnects, in accordance with an exemplary embodiment of the present invention.

FIG. 3d provides a step in a process of fabricating optical interconnects, in accordance with an exemplary embodiment of the present invention.

FIG. 4 provides a schematic of a holder for tilt, in accordance with an exemplary embodiment of the present invention.

FIG. 5 provides variations for 3D waveguides with and without via integration, in accordance with an exemplary embodiment of the present invention.

### DETAILED DESCRIPTION OF THE INVENTION

To facilitate an understanding of the principles and features of the present invention, various illustrative embodiments are explained below. To simplify and clarify explanation, the invention is described below as applied to optical interconnects. One skilled in the art will recognize, however, that the invention is not so limited. Instead, as those skilled in the art would understand, the various embodiments of the present invention also find application in other areas, including, but not limited to, optical interconnects, electrical interconnects and the like.

The components, steps, and materials described hereinafter as making up various elements of the invention are intended to be illustrative and not restrictive. Many suitable components, steps, and materials that would perform the same or similar functions as the components, steps, and materials described herein are intended to be embraced within the scope of the invention. Such other components, steps, and materials not described herein can include, but are not limited to, similar components or steps that are developed after development of the invention.

The present invention relates to interconnects with optical waveguides and methods of fabricating the same. For example, the present invention illustrates a method of fabricating 3D WG that can couple optical through-package vias (“TPVs”) in a 3D ultra-thin glass interposer for chip-to-chip optical communications. Coupling of the devices can be enabled using positive and negative sloped, e.g., 45 degrees, TIR micro-mirrors on ends of the waveguide. The simulated coupling efficiency can be within 0.5 dB for 45±5 degrees. Embodiments of the present invention provide a novel inclined UV photolithography process to fabricate the microstructures simultaneously with self-alignment. The alignment can be inherent because it is resolved prior to inclined photolithography during the planar patterning of double-sided metallization layers. The new process can be used with commercially available printed circuit board (“PCB”) manufacturing technologies.

Embodiments of the invention are capable of overcoming the limitations in the prior art addressed above. For example, to overcome the limitation relating to the critical angle at maximum incident, some embodiments employ a process comprising a fluid (e.g., water) immersion step. Additionally, to overcome the geometrical limitations discussed above, some embodiments use glass as both the mask and substrate, therefore, ensuring zero gap contact with no transfer step. For example, the mask can be created by planar patterning of double-sided metallic (e.g., copper) layers. These layers can also be used in the semi-additive process (“SAP”) for electrical buildup.

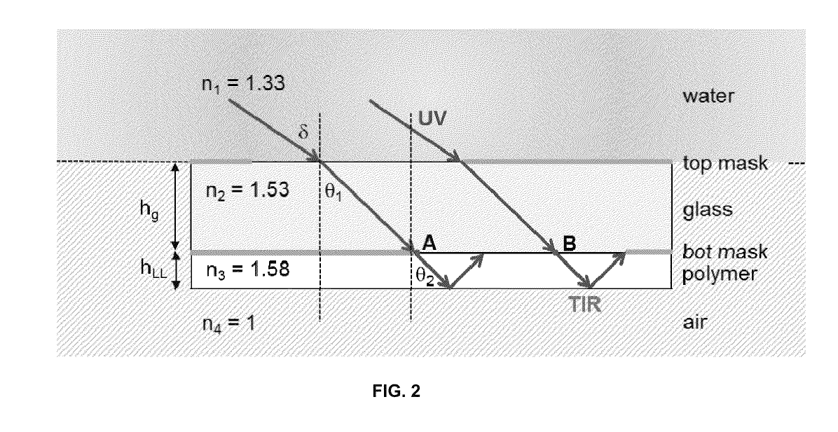

FIG. 2e shows the snapshot of the ray mechanics during exposure in an exemplary embodiment of the present invention. As shown in FIG. 2e, the geometrical limitation described above can overcome by reintroducing an air gap to allow reflection to occur by total internal reflection (“TIR”).

$${θ}_{r} = {sin}^{- 1} ( \frac{{n}_{3}}{{n}_{4}} sin {θ}_{cr} ) \qquad Equation 4$$

Using Equation 4 when θ_{cr}=45 degrees, the argument of the arcsine is greater than 1. Therefore, no refraction occurs and all of the light is reflected.

In addition to the TIR, the double sided metallic mask can be used to obtain a desired symmetry. The bottom side mask can define the onset of the entry turning surface (point A), and the topside mask can define the onset of exit turning surface (point B) with a calculated offset to discussed below. Ultimately, the resulting waveguide can be self-aligned to these masks created by planar lithography.

In an embodiment, the method comprises providing an interconnect structure comprising a planar glass substrate 103. In some embodiments, the substrate can be made of silicon. In other embodiments, the substrate can be made of alumina (Al₂O₃), aluminum nitride (AlN), beryllium oxide (BeO), quartz, ferrites, titanites. In some embodiments, the substrate can be made of ceramic, a polymer-glass laminate, or a flexible polymer. In embodiment, the substrate is selected from the group consisting of glass and silicon. In an exemplary embodiment, the substrate can be made from an optically transparent or optically transmissive material.

The substrate can be of many shapes, for example, wafer, small square or rectangular panel, or large panel shapes. In an exemplary embodiment, the substrate is a thin glass substrate. In an embodiment, the thickness of the substrate can be from about 25 micron to about 500 micron. In some embodiments, the thickness of the substrate can be from about 50 to about 300 micron. In an embodiment, the thickness of the substrate can be about 50 micron, about 100 micron, or about 300 micron.

In an exemplary embodiment, the substrate contains no vias and light can pass directly through the optically transmissive substrate. In one embodiment, the substrate can be provided with at least one pre-formed via. In an embodiment, the method comprises forming a via in the substrate through a method known in the art, such as drilling.

In an exemplary embodiment, the method comprises providing an interconnect structure comprising a planar first metallization layer adjacent to a top side of the glass substrate and a planar second metallization layer adjacent to a bottom side of the glass substrate. In some embodiments, the interconnect structure comprises a metallization layer adjacent to a top side of the substrate. In some embodiments, the interconnect structure comprises a metallization layer adjacent to a bottom side of the substrate. In an embodiment where one or more vias are present in the substrate, the interconnect structure comprises a metallization layer on at least one side wall of the via formed in the substrate. In some embodiments, the interconnect structure comprises a metallization layer on both side walls of the via.

In an embodiment, the method comprises disposing a metallization layer on at least a portion of a top side of the substrate and/or disposing a metallization layer on at least a portion of a bottom side of the substrate. In an embodiment where one or more vias are present in the substrate, the method comprises disposing a metallization layer on at least a portion of at least one side wall of a pre-formed via. In other embodiments, the method comprises disposing a metallization layer on both side walls of the pre-formed via.

In an exemplary embodiment, the thickness of the metallization layer can be substantially the same on the top side of the substrate and the bottom side of the substrate. In an embodiment, the thickness of the metallization layer is the same on the top side of the substrate and the bottom side of the substrate. While not wishing to be bound by theory, it is contemplated that maintaining a consistent metallization layer thickness on both sides of the substrate controls warping of the thin substrate. In an embodiment, the thickness of the metallization layer is the minimum thickness needed to block light.

In an exemplary embodiment, the thickness of the metallization layer can be from about 50 nm to about 1 micron. In an embodiment, the thickness of the metallization layer can be from about 100 nm to about 1 micron. In some embodiments, the thickness of the metallization layer can be from about 100 nm to about 500 nm.

In some embodiments of the present invention, at least one of the first and second metallization layers comprises copper. In some embodiments, the metallization layers comprise a metal that is not optically transmissive, including, but not limited to chrome, nichrome, tantalum nitride, titanium tungsten, copper, nickel, gold and aluminum, titanium. In an embodiment, the metallization layers can be a polymer that is not optically transmissive. In one embodiment, the metallization layers can be copper/titanium layers. In an embodiment, the metallization layer is a metallization seed layer.

In an exemplary embodiment, the metallization layers can be patterned using photolithography. Other patterning techniques are contemplated, such as any common lithography techniques including, but not limited to, electron beam lithography, imprint lithograph, ion beam lithography, laser beam lithography, nanolithography, nanoimprint, and laser patterning.

In an exemplary embodiment, the method comprises providing an interconnect structure comprising a planar first photoresist layer adjacent to a top side of the first metallization layer opposite the substrate, and a planar second photoresist layer adjacent to a bottom side of the second metallization layer opposite the substrate. The photoresist material can be any light-sensitive material used in photolithography.

In an exemplary embodiment, the method further comprises using the first photoresist layer to etch a portion of the first metallization layer to form a first aperture in the first metallization layer and using the second photoresist layer to etch a portion of the second metallization layer offset from the portion of the first metallization layer to form a second aperture in the second metallization layer.

In an embodiment, the photoresist layers can be deposited on the metallization layers by known processes, such as lamination. After deposition of the photoresist, the photoresist can be exposed using known methods and upon exposure and development of the photoresist, the metallization layers can be etched to form the resulting apertures.

In an exemplary embodiment, the method further comprises removing at least one of the first and second photoresist layers. The photoresist layers can be removed using techniques known in the art, such as solvent stripping, combustion, oxygen plasma removal, and the like.

In an exemplary embodiment, the method further comprises depositing a planar photo-definable material layer adjacent to a bottom side of the second metallization layer opposite the glass substrate. In an embodiment, the photo-definable material can be deposited adjacent to a top side of the first metallization layer. In some embodiments, the photo-definable material can be deposited adjacent to a side of the substrate.

In an exemplary embodiment, the photo-definable material can be spin-coated onto the second metallization layer. In other embodiments, the photo-definable material can be deposited via other deposition techniques, including, but not limited to chemical deposition such as plating, chemical solution deposition, spin coating, chemical vapor deposition (CVD), plasma enhanced CVD, or atomic layer deposition (ALD). In other embodiments, the photo-definable material can be deposited via physical deposition techniques, including, but not limited to, electron beam evaporation, molecular beam epitaxy (MBE), sputtering, pulsed laser deposition, and the like.

In an exemplary embodiment, the waveguide comprises a photo-definable material. In an embodiment, the photo-definable material can be an optical polymer or other optically transmissive or optically transparent material. An optically transmissive or optically transparent material can be defined as a material that has low optical loss. In an embodiment, the photo-definable material is a low-loss polymer. In an embodiment, the photo-definable material is a negative-type material. In some embodiments, the photo-definable material is an inorganic optically transmissive material, including, but not limited to silicon nitride (SiN). In an exemplary embodiment, the photo-definable material is an optical polymer. In an embodiment, the photo-definable material is a siloxane-based material. In an embodiment, the photo-definable material is a siloxane-based polymer, such as LIGHTLINK™. In some embodiments, the photo-definable material is a benzocyclobutene material, such as a benzocyclobutene-based polymer. In some embodiments, the photo-definable material is a photosensitive polymer, which one of ordinary skill in the art would recognize as a polymer that responds to ultraviolet or visible light by exhibiting a change in its physical properties or its chemical constitution. In some embodiments of the present invention, the photo-definable material layer comprises a negative tone material. In some embodiments of the present invention, the photo-definable material layer comprises a low-loss polymer.

In an exemplary embodiment, the method further comprises immersing at least a bottom portion of the photo-definable material layer in a fluid having a refractive index different from a refractive index of the substrate. In an exemplary embodiment, at least one side of the interconnect structure can be immersed in the fluid and at least a second side of the interconnect structure can be in contact with air. In an embodiment, the method further comprises immersing at least a portion of the bottom side of the interconnect structure in the fluid. In an embodiment, at least a portion of the top side of the interconnect structure can be immersed in the fluid. In some embodiments, the photo-definable material can be immersed in the fluid and the opposite side of the interconnect structure can be exposed to air. In some embodiments, the photo-definable material can be exposed to air and the opposite side of the interconnect structure and be immersed in the fluid. In some embodiments, the fluid can be water with a refractive index of 1.33. In an embodiment, the fluid can be deionized water. In an embodiment, the fluid, substrate, photo-definable material, and air all have different refractive indices.

In an exemplary embodiment, the method further comprises applying light at a non-normal angle to the top side of the first metallization layer. In some embodiments, the light can be applied at a non-normal angle by modifying the angle of the incident beam to the desired angle. In an embodiment, the light can be applied at a non-normal angle by placing the interconnect structure in a holding apparatus and tilting the holding apparatus and interconnect structure to the desired angle.

In an exemplary embodiment, application of the light can cause at least a portion of the light to traverse through the first aperture, the glass substrate, and the second aperture to be incident upon the photo-definable material layer and so that at least a second portion of the light is reflected by the fluid, forming a waveguide in the photo-definable material. In some embodiments, the formed waveguide can be a turning waveguide. In an embodiment, the formed waveguide can comprise a first end adjacent a first end of the etched portion of the second metallization layer and a second end adjacent a second end of the etched portion of second metallization layer. In an embodiment, the waveguide can be formed in the aperture on a bottom side of the substrate.

In some embodiments of the present invention at least one of the first and second ends of the formed waveguide can define an acute angle with respect to a top surface of the formed waveguide proximate the glass substrate. In an embodiment of the present invention, the acute angle is between 35 and 55 degrees. In some embodiments of the present invention, the acute angle is between 40 and 50 degrees. In some embodiments of the present invention, the acute angle is 45 degrees. In an embodiment with vias formed in the substrate, the angle can be between about 42 degrees and about 47 degrees and provide less than about 0.5 dB of light loss. In an embodiment where the substrate contains no vias, the angle can be between about 43 degrees and about 46 degrees and provide less than about 0.5 dB of light loss.

In some embodiments of the present invention, an angle defined by the first end of the formed waveguide with respect to a top surface of the formed waveguide proximate the glass substrate can be different than an angle defined by the second end of the formed waveguide with respect to the top surface of the formed waveguide proximate the glass substrate. In an embodiment, an angle defined by the first end of the formed waveguide can be an acute angle with respect to the top surface of the formed waveguide proximate the glass substrate and the angle formed by the second end of the formed waveguide can be 90 degrees, or normal with respect to the top surface of the formed waveguide proximate the glass substrate.

In some embodiments of the present invention, the method further comprises determining the non-normal angle at which the light is applied based at least in part on a desired angle to be defined by at least one of the first and second ends of the formed waveguide with respect to a top surface of the formed waveguide proximate the glass substrate.

In some embodiments of the present invention, the method further comprises determining an offset between a first end of the etched portion of the first metallization layer and a first end of the etched portion of the second metallization layer based at least in part on a desired length of the formed waveguide. In an embodiment, the front to back offset can be determined by the equation:

Offset=h_{g} tan θ₁+2h_{LL} tan θ₂.

In some embodiments of the present invention, the method further comprises etching an elliptically-shaped ring into the top side of the glass substrate opposite the first end of the formed waveguide. As used herein “elliptically-shaped” can be many different ellipses known in the art including, but not limited to, circles, and the like.

In some embodiments of the present invention, the method further comprises at least partially filling the elliptically-shaped ring with a cladding material. In an embodiment, the ring can be filled with the cladding material using a vacuum filling process to avoid voids in the ring.

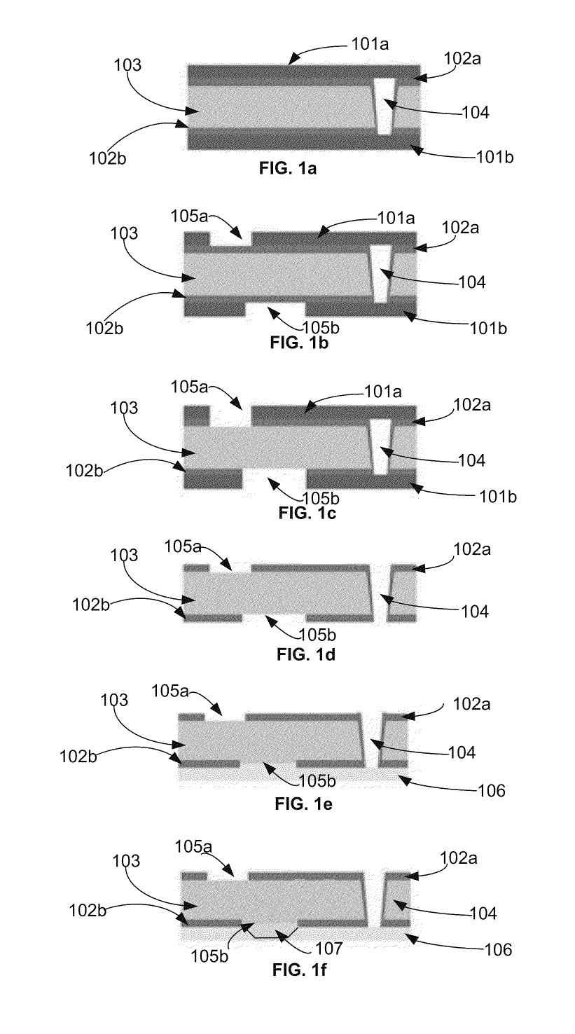

Turning to FIG. 1a, another embodiment of the present invention provides a method of fabricating an optical interconnect comprising providing an interconnect structure comprising a planar glass substrate 103, a planar first metallization layer adjacent 102a to a top surface of the glass substrate 103, and a planar second metallization layer 102b adjacent to a bottom surface of the glass substrate 103. In an embodiment, the interconnect structure can comprise a first photoresist layer 101a and a second photoresist layer 101b. In an embodiment, the substrate 103 can comprise a via 104.

Turning to FIG. 1b, in an embodiment, the method can further comprise forming a first aperture 105a through the first photoresist layer 101a and a second aperture 105b through the second photoresist layer 101b.

Turning to FIG. 1c, in an embodiment, the method can further comprise forming a first aperture 105a through the first metallization layer 102a, forming a second aperture 105b through the second metallization layer 102b, wherein the first aperture 105a is offset from the second aperture 105b. Turning to FIG. 1d, in an embodiment, the method can further comprise removing the first and second photoresist layers.

Turning to FIG. 1e and FIG. 1f, in an embodiment, the method can further comprise depositing a photo-definable material layer 106 adjacent to a bottom surface of the second metallization layer 102b opposite the glass substrate 103, immersing at least a portion of the photo-definable material layer 106 in a fluid having a refractive index that is different from a refractive index of the glass substrate 103, and applying light at a non-normal angle to a top surface of the first metallization layer 102a opposite the glass substrate 103 so that at least a first portion of the light traverses through the first aperture 105a, the glass substrate 103, and the second aperture 105b to be incident upon the photo-definable material layer 106 and so that at least a second portion of the light is reflected by the fluid, forming a waveguide 107 in the photo-definable material.

In some embodiments of the present invention, the formed waveguide 107 comprises a first end adjacent a first end of the second aperture 105b and a second end adjacent a second end of the second aperture 105b.

In some embodiments of the present invention, the method further comprises determining the non-normal angle at which the light is applied based at least in part on a desired acute angle to be defined by at least one of the first and second ends of the formed waveguide with respect to a top surface of the formed waveguide proximate the glass substrate. Turning to FIG. 2, as a non-limiting example, in an embodiment, the fluid can be water with a refractive index of 1.33, the substrate can be Corning glass with a refractive index of 1.53, the polymer can have a refractive index 1.58, and air can have a refractive index of 1.

In some embodiments of the present invention, the method further comprises etching an elliptically-shaped ring into the top surface of the glass substrate opposite the first end of the formed waveguide.

In some embodiments of the present invention, the method further comprises at least partially filling the elliptically-shaped ring with a cladding material.

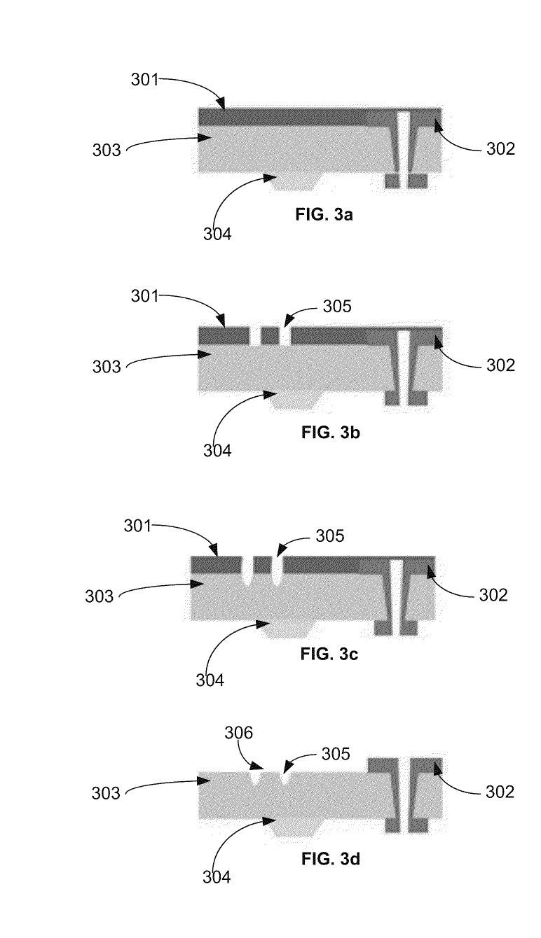

As shown in FIG. 3a, in an embodiment, a photoresist layer 301 can be disposed on at least a top side of the interconnect which includes substrate 303 and preformed waveguide 304. In an embodiment, the interconnect can further comprise a metalized via 302. Turning to FIGS. 3b and 3c, the photoresist 301 can be used to etch at least one elliptically-shaped ring 305 into the substrate 303. Turning to FIG. 3d, the photoresist layer can then be stripped using common techniques discussed herein. The elliptically-shaped ring 305 substantially surrounds a second position 306. The second position 306 can be aligned with a side of waveguide 305 such that light can be confined vertically through second position 306.

In some embodiments of the present invention, the method further comprises determining the offset between a first end of the first aperture and a first end of the second aperture based at least in part on a desired length of the formed waveguide.

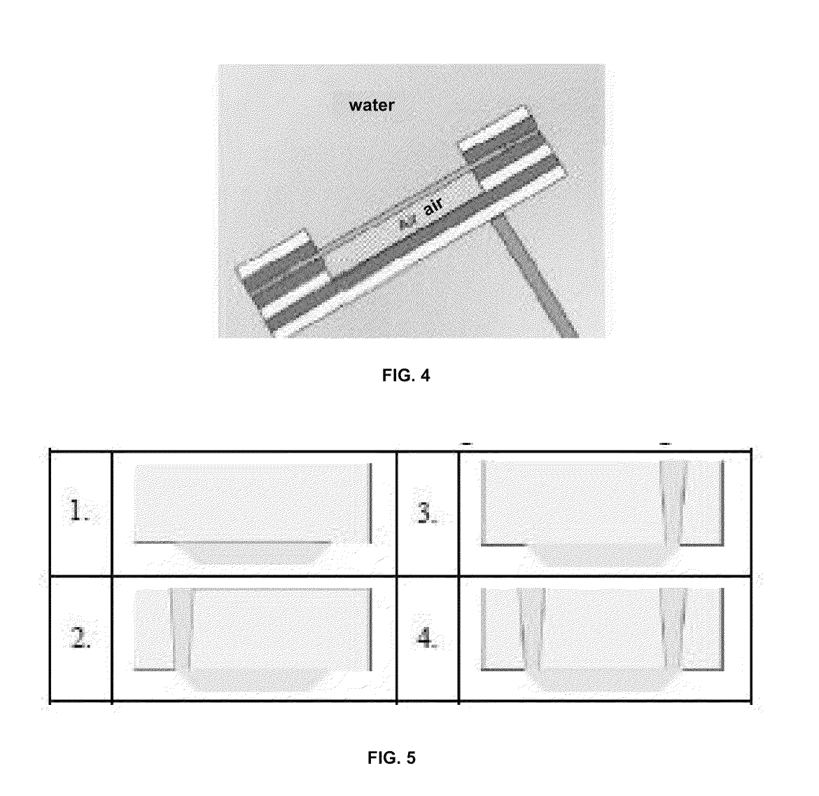

In an exemplary embodiment, the method further comprises applying light at a non-normal angle to the top side of the first metallization layer. In some embodiments, the light can be applied at a non-normal angle by modifying the angle of the incident beam to the desired angle. As shown in FIG. 4, in an embodiment, the light can be applied at a non-normal angle by placing the interconnect structure in a holding apparatus and tilting the holding apparatus and interconnect structure to the desired angle.

Another embodiment of the present invention provides an optical interconnect. The optical interconnect can comprise a planar first metallization layer, a planar second metallization layer, a glass substrate disposed between the at least portions of the first and second metallization layers, a first aperture in the second metallization layer having a first end and a second end, and a polymer waveguide having a first end adjacent the first end of the first aperture. The first end of the waveguide can have a first edge defining a first acute angle with respect to a top surface of the waveguide proximate a bottom surface of the glass substrate. The first end of the optical waveguide can be configured to receive an optical signal traversing through the glass substrate from a source proximate a first position on a top surface of the glass substrate and direct the optical signal with the first edge in a direction parallel to the glass substrate towards a second end of the waveguide.

In one embodiment, the waveguide can be configured to receive an optical signal traversing directly through the glass substrate without the need for a via in the substrate. In another embodiment, the signal can traverse through a via formed in the substrate. FIG. 5 shows various embodiments contemplated by the present invention wherein (1.) the light traverses through the substrate without the need for a via in the substrate; (2.) and (3.) the light traverses through one via in the substrate; and (4.) the light traverses through two vias in the substrate.

In some embodiments of the present invention, the first acute angle can be between 35 degrees and 60 degrees. In some embodiments of the present invention, the first acute angle can be 45 degrees.

In some embodiments of the present invention, the glass substrate can further comprise a elliptically-shaped ring etched into the glass substrate and surrounding the first position on the top surface of the glass substrate. The ring can be configured to limit the dispersion of the optical source in the glass substrate.

In some embodiments of the present invention, the elliptically-shaped ring can be at least partially filled with a cladding material.

In some embodiments of the present invention, the second end of the waveguide can have a second edge defining a second acute angle with respect to the top surface of the waveguide proximate the bottom surface of the glass substrate.

In some embodiments of the present invention, the second acute angle is between 40 degrees and 50 degrees. In some embodiments of the present invention, the second acute angle is 45 degrees. In some embodiments of the present invention, the acute angle is between 40 and 50 degrees. In an embodiment with vias formed in the substrate, the angle can be between about 42 degrees and about 47 degrees and provide less than about 0.5 dB of light loss. In an embodiment where the substrate contains no vias, the angle can be between about 43 degrees and about 46 degrees and provide less than about 0.5 dB of light loss.

In some embodiments of the present invention, the first acute angle is different than the second acute angle. In an embodiment, an angle defined by the first end of the formed waveguide can be an acute angle with respect to the top surface of the formed waveguide proximate the glass substrate and the angle formed by the second end of the formed waveguide can be 90 degrees, or normal with respect to the top surface of the formed waveguide proximate the glass substrate.

In some embodiments of the present invention, the second end of the optical waveguide can be configured to direct the optical signal with the second edge through the glass substrate in a direction perpendicular to the glass substrate to a destination proximate a second position on a top surface of the glass substrate.

In some embodiments of the present invention, the glass substrate can further comprise an elliptically-shaped ring etched into the glass substrate and surrounding the second position on the top surface of the glass substrate. The ring can be configured to limit the dispersion of the optical source in the glass substrate.

In some embodiments of the present invention, the elliptically-shaped ring can be at least partially filled with a cladding material. The cladding material can further limit the dispersion of the optical source in the glass substrate.

It is to be understood that the embodiments and claims disclosed herein are not limited in their application to the details of construction and arrangement of the components set forth in the description and illustrated in the drawings. Rather, the description and the drawings provide examples of the embodiments envisioned. The embodiments and claims disclosed herein are further capable of other embodiments and of being practiced and carried out in various ways. Also, it is to be understood that the phraseology and terminology employed herein are for the purposes of description and should not be regarded as limiting the claims.

Accordingly, those skilled in the art will appreciate that the conception upon which the application and claims are based may be readily utilized as a basis for the design of other structures, methods, and systems for carrying out the several purposes of the embodiments and claims presented in this application. It is important, therefore, that the claims be regarded as including such equivalent constructions.

Furthermore, the purpose of the foregoing Abstract is to enable the United States Patent and Trademark Office and the public generally, and especially including the practitioners in the art who are not familiar with patent and legal terms or phraseology, to determine quickly from a cursory inspection the nature and essence of the technical disclosure of the application. The Abstract is neither intended to define the claims of the application, nor is it intended to be limiting to the scope of the claims in any way. Instead, it is intended that the invention is defined by the claims appended hereto.

What is claimed is:

1. A method of fabricating an optical interconnect, comprising:
providing a interconnect structure comprising:
a planar glass substrate;
a planar first metallization layer adjacent to a top side of the glass substrate;
a planar second metallization layer adjacent to a bottom side of the glass substrate;
a planar first photoresist layer adjacent to a top side of the first metallization layer opposite the glass substrate; and
a planar second photoresist layer adjacent to a bottom side of the second metallization layer opposite the glass substrate;
using the first photoresist layer to etch a portion of the first metallization layer to form a first aperture in the first metallization layer;
using the second photoresist layer to etch a portion of the second metallization layer offset from the portion of the first metallization layer to form a second aperture in the second metallization layer;
removing the first and second photoresist layers;
depositing a planar photo-definable material layer comprising a negative tone material adjacent to a bottom side of the second metallization layer opposite the glass substrate;
immersing at least a bottom portion of the photo-definable material layer in a fluid having a refractive index different from a refractive index of the glass substrate; and
applying light at a non-normal angle to the top side of the first metallization layer,
wherein application of the light causes the at least a portion of the light to traverse through the first aperture, the glass substrate, and the second aperture to be incident upon the photo-definable material layer and so that at least a second portion of the light is reflected by the fluid, forming a waveguide in the photo-definable material, and
wherein the formed waveguide comprises a first end adjacent a first end of the etched portion of the second metallization layer and a second end adjacent a second end of the etched portion of second metallization layer,
wherein at least one of the first and second ends of the formed waveguide defines an acute angle between 40 and 50 degrees with respect to a top surface of the formed waveguide proximate the glass substrate.

2. A method of fabricating an optical interconnect, comprising:
providing a interconnect structure comprising:
a planar glass substrate;
a planar first metallization layer adjacent to a top surface of the glass substrate; and
a planar second metallization layer adjacent to a bottom surface of the glass substrate;
forming a first aperture through the first metallization layer;
forming a second aperture through the second metallization layer, wherein the first aperture is offset from the second aperture;
depositing a photo-definable material layer adjacent to a bottom surface of the second metallization layer opposite the glass substrate;
immersing at least a portion of the photo-definable material layer in a fluid having a refractive index that is different from a refractive index of the glass substrate; and
applying light at a non-normal angle to a top surface of the first metallization layer opposite the glass substrate so that at least a first portion of the light traverses through the first aperture, the glass substrate, and the second aperture to be incident upon the photo-definable material layer and so that at least a second portion of the light is reflected by the fluid, forming a waveguide in the photo-definable material.

3. The method of claim 2, wherein the formed waveguide comprises a first end adjacent a first end of the second aperture and a second end adjacent a second end of the second aperture.

4. The method of claim 3, further comprising determining the non-normal angle at which the light is applied based at least in part on a desired acute angle to be defined by at least one of the first and second ends of the formed waveguide with respect to a top surface of the formed waveguide proximate the glass substrate.

5. The method of claim 3, further comprising etching an elliptically-shaped ring into the top surface of the glass substrate opposite the first end of the formed waveguide.

6. The method of claim 5, further comprising at least partially filling the elliptically-shaped ring with a cladding material.

7. The method of claim 2, further comprising determining the offset between a first end of the first aperture and a first end of the second aperture based at least in part on a desired length of the formed waveguide.

8. An optical interconnect comprising:
a planar first metallization layer
a planar second metallization layer;
a glass substrate disposed between at least portions of the first and second metallization layers;
a first aperture in the second metallization layer having a first end and a second end; and
a polymer waveguide having a first end adjacent the first end of the first aperture, the first end of the waveguide having a first edge defining a first acute angle with respect to a top surface of the waveguide proximate a bottom surface of the glass substrate,
wherein the first end of the optical waveguide is configured to receive an optical signal traversing through the glass substrate from a source proximate a first position on a top surface of the glass substrate and direct the optical signal with the first edge in a direction parallel to the glass substrate towards a second end of the waveguide.

9. The method of claim 8, wherein the first acute angle is between 40 degrees and 50 degrees.

10. The method of claim 8, wherein the first acute angle is 45 degrees.

11. The optical interconnect of claim 8, wherein the glass substrate further comprises a elliptically-shaped ring etched into the glass substrate and surrounding the first position on the top surface of the glass substrate, the ring configured to limit the dispersion of the optical source in the glass substrate.

12. The optical interconnect of claim 8, wherein the elliptically-shaped ring is at least partially filled with a cladding material.

13. The method of claim 8, wherein the second end of the waveguide has a second edge defining a second acute angle with respect to the top surface of the waveguide proximate the bottom surface of the glass substrate.

14. The method of claim 13, wherein the second acute angle is between 40 degrees and 50 degrees.

15. The method of claim 13, wherein the second acute angle is 45 degrees.

16. The method of claim 13, wherein the first acute angle is different than the second acute angle.

17. The method of claim 13, wherein the second end of the optical waveguide is configured to direct the optical signal with the second edge through the glass substrate in a direction perpendicular to the glass substrate to a destination proximate a second position on a top surface of the glass substrate.

18. The optical interconnect of claim 13, wherein the glass substrate further comprises an elliptically-shaped ring etched into the glass substrate and surrounding the second position on the top surface of the glass substrate, the ring configured to limit the dispersion of the optical source in the glass substrate.

19. The optical interconnect of claim 18, wherein the elliptically-shaped ring is at least partially filled with a cladding material.
